(19) United States
(12) Patent Application Publication
(10) Pub. No.: US 2023/0289896 A1
(43) Pub. Date: Sep. 14, 2023

(54) GROUP ACCOUNTS

(71) Applicant: Meta Platforms, Inc., Menlo Park, CA (US)

(72) Inventors: Ryan Keenan Olson, Aspen, CO (US); Shilpa Sarkar, La Jolla, CA (US); Josselyn Tsai, Montauk, NY (US); Christopher Wendel, Brooklyn, NY (US); Peter Michael Cottle, Boulder, CO (US); Ian McIntyre Silber, San Francisco, CA (US)

(21) Appl. No.: 17/654,106

(22) Filed: Mar. 9, 2022

(51) Int. Cl. G06Q 50/00

(52) U.S. Cl. CPC G06Q 50/01

(57) ABSTRACT

Techniques are described for a social networking system to provide group or aggregation accounts that allow users to easily and quickly form relationships with multiple other users based on a membership association of the multiple users to the group account. In some cases, the social networking system may be configured to add and/or remove relationships based on changes in association between members and the group account.

### BACKGROUND

Social networking systems provide users with functionality to share content with other users. Most conventional social networking systems provide sharing in a one-to-one or one-to-many relationship via a user's account or page. However, there are times when multiple users work together on a project or participate together in an event and in which a user of the social networking system may desire information and notification associated with multiple individuals associated with the group project. However, currently, conventional systems require a user to create a relationship with each individual group member, which may be a time consuming and tedious process.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a view of an example social networking system associated with creation of group accounts, according to some implementations.

FIG. 2 is a view of an example social networking system associated with managing followers of a group account, according to some implementations.

FIG. 3 is a view of an example social networking system associated with managing followers of a group account, according to some implementations.

FIG. 4 is a view of an example social networking system associated with managing group members of a group account, according to some implementations.

FIG. 5 is a view of an example social networking system associated with managing group members of a group account, according to some implementations.

FIG. 6 is a flow diagram illustrating an example process associated with creation group accounts, according to some implementations.

FIG. 7 is another flow diagram illustrating an example process associated with managing followers of a group account, according to some implementations.

FIG. 8 is another flow diagram illustrating an example process associated with managing followers of a group account, according to some implementations.

FIG. 9 is another flow diagram illustrating an example process associated with managing members of a group account, according to some implementations.

FIG. 10 is another flow diagram illustrating an example process associated with managing members of a group account, according to some implementations.

FIG. 11 is an example system and device that is usable to implement the techniques described herein according to some implementations.

### DETAILED DESCRIPTION

Social networking systems and websites are often used to easily access information associated with individuals, projects, events, companies, programs, and the like. For example, a user may register, indicate, or sign up (e.g., “follow”) to receive updates and notification related to content generated, interacted with, liked, posted, etc. by one or more other user accounts of the social networking system. However, many of the conventional social networking systems are directed to one to one relationships and assisting the users in providing and receiving information or content in the form of text, images, video, and the like on an individual basis. For example, in conventional systems, content is posted, managed, shared, and/or stored with respect to a single user and a single user's account. Other users may then follow individual user accounts to receive the associated content.

Unfortunately, a user may be interested in a group of users, such as organizers of an event or fundraiser, cast of a television program or movie, members of groups or committees, and the like. In the conventional systems, a user may follow, if available, the account associated with the organization or program (e.g., the account for a television program) but the user would only receive content posted by the administrator of the organization or program account. However, often the user may be interested in the content posted by the individual members of the account. In these cases, the user of the conventional social networking system is often required to manually follow each individual user account of, for instance, the cast of the television program. This process may be time consuming and tedious, as well as consuming additional network and computer resources as the user navigates to and interacts with each individual user account.

In addition, in many cases the members of the group (e.g., the cast of the television program) may change from time to time (e.g., a new cast member is added, or an existing cast member is removed). In conventional systems, a user may not even be aware of the change in group membership thereby missing content associated with the new cast member and, if the user is aware, the user is again required to manually navigate to the newly added members account and initiate a follow action. In some cases, if the change in membership happens often, the tasks of updating the following of the individual users may be time intensive and consume unnecessary network, processing, and computing resources.

The social networking system, discussed herein, may provide for a group account. For example, the group account may be associated with a particular group of individuals or group members (e.g., the cast of the television program, organizers of an event, a set of topic experts, a group of friends, or the like). The group account may also include an individual administrator or administrator account that is capable of adding content and maintaining a membership list for the group account. In this example, the administrator may both add group members and remove group members based on various criteria, such as a relevancy to the topic of the group account (e.g., as cast members are added and removed from the television program).

Any individual user of the social networking system may then follow or associate with the group account. The social networking system may, in response to the following of the group account, cause the individual account to follow each of the individual accounts of the group members. In this manner, the individual user may navigate to the group account and perform a single follow action to be associated with or otherwise follow the individual accounts of each member of the group account. Likewise, if a group member is added to the group account, the social networking system may cause the individual user to follow the newly added group member's account without any additional action by the user. In some cases, the social networking system may also cause the individual user to unfollow a group member if the group member is removed from the group account. In this manner, the social networking system discussed herein may allow for management of followers for a group of users without relying on the individual users to take action on a regularly basis.

In some examples, the group account may be public and available such that any user may sign up as a member. For example, a group account on climate change may be open such that any user that posts content related to climate change may sign up or add themselves as a member. In other examples, the group account may be private and include an administrator that manages the member list, as discussed above.

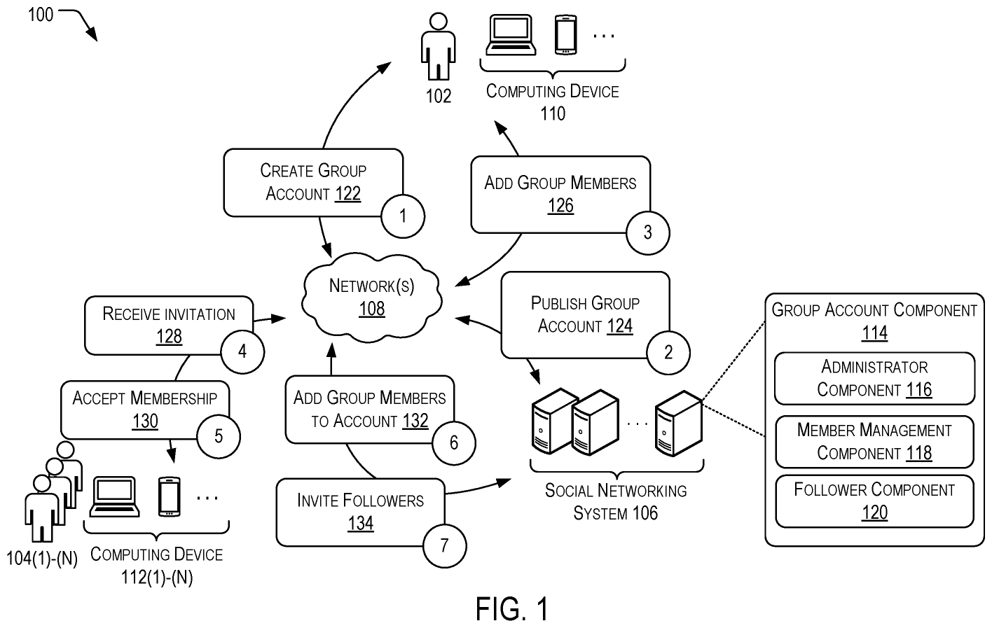

FIG. 1 is a view of an example system 100 usable to provide group accounts for reduced resource and time consumption associated with following and unfollowing user accounts, according to some implementations. In some examples, the system 100 may include an administrator user 102 (also referred to simply as “user”) that may be an original account creator of a group account and/or another user assigned to the role of managing the member list. The group account may also include members, such as users 104(1)-104(N) (collectively “users 104 or members 104”). As discussed herein, the administrator user 102 and the members 104 may interact with a social networking system 106 via a network 108 using computing devices, generally indicated by 110 and 112(1)-(N), respectively. In some cases, the group account may include more than one administrator, but is referred to herein as a single user for clarity.

In the illustrated example, the social networking system 106 may include a group account component 114. The group account component 114 may include a number of sub-components or modules, such as an administrator component 116, a member management component 118, and/or a follower component 120. The administrator component 116 may provide the administrator user 102 with functionality to manage the group account content and information. The member management component 118 may be configured to allow the administrator user 102 to manage the member list of the group account (e.g., add and remove members) including the members 104. The follower component 120 may be configured to provide follow and unfollow actions on behalf of users following the group account when members are added or removed from the group account as well as when a user initially follows/unfollows the group account.

With respect to FIG. 1, the administrator user 102 may be creating a group account for the users 104, for example, upon a launch announcement of an upcoming television program. For instance, in the illustrated example, the administrator user 102 may, at operation 122 (indicated by “1”), create a new group account. For instance, the administrator user 102 may create an account in a manner of an individual user creating a personal account but select a group or aggregation account option allowing multiple user accounts to be group members. In some cases, the administrator user 102 may specify identifying content (e.g., account name, address, and the like), background content (e.g., account story, purpose, goals, and the like), demographic or contact content (e.g., personal information of the group), initial content (e.g., original posts and the like), and the like.

In the illustrated example, at operation 124, (indicated by “2”), the social networking system 106 may create and/or publish the collective account. For example, if the account is a public account, the social networking system 106 may publish a page or space associated with the group account as well as any original content generated and/or recorded by the administrator user 102.

Next, at operation 126 (indicated by “3”), the administrator user 102 may add the users 104 to act as members with respect to the group account. For example, the administrator user 102 may select the users 104 by typing or entering the user's name, selecting the user 104 from a list or other tagged content, and the like. In some cases, the member may be an invitation that is provided to the users 104 that must be accepted prior to the user 104 becoming a member, while in other cases, the members may be added without an acceptance or following a period of time elapsing without the user 104 opting-out of the group membership. In this example, operation 126 is separated from operation 124 but it should be understood that in some cases, the administrator user 102 may add members during the creation of the group account.

At operation 128 (indicated by “4”), the users 104 may receive the invitation from the administrator user 102 via the social networking system 106. For example, the users 104 may receive a notification or alert as to the creation and/or invitation to the group account with the option to accept. At operation 130 (indicated by “5”), the users 104 may accept the invitation to be added as a member with respect to the group account.

In this example, at operation 132 (indicated by “6”), the social networking system 106 may add the users 104 that accepted the invitation as members to the group account. Once added, any user that follows the group account may become a follower of the users 104. The user 104 may also be listed as members with respect to the group account and/or content associated therewith. The social networking system may also, at operation 134 (indicated by “7”), invite followers associated with each individual user 104 to follow the group account. For example, the followers of the users 104 may receive a notification informing the followers that the user 104 has joined the group account and ask the followers if they would also like to follow the group account.

In the illustrated example, each of the computing devices 110 and 112 may include one or more processors and memory storing computer executable instructions to implement the functionality discussed herein attributable to the various computing devices. In some examples, the computing devices 110 and 112 may include desktop computers, laptop computers, tablet computers, mobile devices (e.g., smart phones or other cellular or mobile phones, mobile gaming devices, portable media devices, etc.), or other suitable computing devices. The computing devices 110 and 112 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 110 and 112 may access the social networking system 106 and/or communicate with one another.

The social networking system 106 may include one or more servers or other computing devices, any or all of which may include one or more processors and memory storing computer executable instructions to implement the functionality discussed herein attributable to the social networking system or digital platform. The social networking system 106 may enable its users 102 and 104 (such as persons or organizations) to interact with the social networking system 106 and with each other via the computing devices 110 and 112. The social networking system 106 may, with input from a user, create and store in the social networking system 106 a user account associated with the user. The user account may include demographic information, communication-channel information, and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the users.

In some examples, the social networking system 106 may provide privacy features to the users 102 and 104 while interacting with the social networking system 106. In particular examples, one or more objects (e.g., content or other types of objects) of the system 106 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular user or other entity to access that object, the object may be described as being “visible” with respect to that user or other entity. As an example, and not by way of limitation, a user of the online social network may specify privacy settings for a user-profile page that identify a set of users that may access work-experience information on the user-profile page, thus excluding other users from accessing that information.

In particular examples, privacy settings for an object may specify a “blocked list” and/or a “restricted list” of users or other entities that should not be allowed to access certain information associated with the object. In particular examples, the blocked list may include third-party entities. The blocked list or restricted list may specify one or more users or entities for which an object is not visible. As an example, and not by way of limitation, a user may specify a set of users who may not access photo albums associated with the user, thus excluding those users from accessing the photo albums (while also possibly allowing certain users not within the specified set of users to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by users tagged in the photo and friends of the users tagged in the photo. In particular examples, privacy settings may allow users to opt in to or opt out of having their content, information, or actions stored/logged by the social-networking system or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other users of the online social network. Similarly, the privacy settings applied to a particular node may control whether the user or concept corresponding to the node is visible to other users of the online social network. As an example, and not by way of limitation, a user, such as a user 102 and 104, may share an object to the social networking system 106. The object may be associated with a concept node connected to a user node of the user 102 and/or 104 by an edge. The user 102 and/or 104 may specify privacy settings that apply to a particular edge connecting to the concept node of the object or may specify privacy settings that apply to all edges connecting to the concept node. In some examples, the user 102 and/or 104 may share a set of objects of a particular object-type (e.g., a set of images). The user 102 and/or 104 may specify privacy settings with respect to all objects associated with the user 102 and/or 104 of that particular object-type as having a particular privacy setting (e.g., specifying that all images posted by the user 102 and/or 104 are visible only to friends of the user and/or users tagged in the images).

In particular examples, the social networking system 106 may present a “privacy wizard” (e.g., within a webpage, a module, one or more dialog boxes, or any other suitable interface) to the user 102 and/or 104 to assist the user in specifying one or more privacy settings. The privacy wizard may display instructions, suitable privacy-related information, current privacy settings, one or more input fields for accepting one or more inputs from the first user specifying a change or confirmation of privacy settings, or any suitable combination thereof. In particular examples, the social networking system 106 may offer a “dashboard” functionality to the user 102 and/or 104 that may display, to the user 102 and/or 104, current privacy settings of the user 102 and/or 104. The dashboard functionality may be displayed to the user 102 and/or 104 at any appropriate time (e.g., following an input from the user 102 and/or 104 summoning the dashboard functionality, following the occurrence of a particular event or trigger action). The dashboard functionality may allow the user 102 and/or 104 to modify one or more of the user's current privacy settings at any time, in any suitable manner (e.g., redirecting the user 102 and/or 104 to the privacy wizard).

Privacy settings associated with an object may specify any suitable granularity of permitted access or denial of access. As an example and not by way of limitation, access or denial of access may be specified for particular users (e.g., only me, my roommates, my boss), users within a particular degree-of-separation (e.g., friends, friends-of-friends), user groups (e.g., the gaming club, my family), user networks (e.g., employees of particular employers, students or alumni of particular university), all users (“public”), no users (“private”), users of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers of the social networking system 106 may be authorization/privacy servers for enforcing privacy settings. In response to a request from the user 102 and/or 104 (or other entity) for a particular object stored in a data store, the social networking system 106 may send a request to the data store for the object. The request may identify the user 102 and/or 104 associated with the request and the object may be sent only to the user 102 and/or 104 (or a client system of the user) if the authorization server determines that the user 102 is authorized to access the object based on the privacy settings associated with the object. If the requesting user is not authorized to access the object, the authorization server may prevent the requested object from being retrieved from the data store or may prevent the requested object from being sent to the user. In the search-query context, an object may be provided as a search result only if the querying user is authorized to access the object, e.g., if the privacy settings for the object allow it to be surfaced to, discovered by, or otherwise visible to the querying user. In particular examples, an object may represent content that is visible to a user through a newsfeed of the user. As an example, and not by way of limitation, one or more objects may be visible to a user's “Trending” page. In particular examples, an object may correspond to a particular user. The object may be content associated with the particular user, or may be the particular user's account or information stored on the social networking system 106, or other computing systems. As an example, and not by way of limitation, the user 102 and/or 104 may view one or more other users 102 and/or 104 of an online social network through a “People You May Know” function of the online social network, or by viewing a list of friends of the user 102. As an example, and not by way of limitation, the user 102 and/or 104 may specify that they do not wish to see objects associated with a particular other user (e.g., the user 102 and/or 104) in their newsfeed or friends list. If the privacy settings for the object do not allow it to be surfaced to, discovered by, or visible to the user 102 and/or 104, the object may be excluded from the search results. Although this disclosure describes enforcing privacy settings in a particular manner, this disclosure contemplates enforcing privacy settings in any suitable manner.

In particular examples, different objects of the same type associated with a user may have different privacy settings. Different types of objects associated with a user may also have different types of privacy settings. As an example, and not by way of limitation, the user 102 and/or 104 may specify that the user's status updates are public, but any images shared by the user are visible only to the user's friends on the online social network. In some examples, the user 102 and/or 104 may specify different privacy settings for different types of entities, such as individual users, friends-of-friends, followers, user groups, or corporate entities. In some examples, the user 102 and/or 104 may specify a group of users that may view videos posted by the user 102 and/or 104, while keeping the videos from being visible to the user's employer. In particular examples, different privacy settings may be provided for different user groups or user demographics. As an example, and not by way of limitation, the user 102 and/or 104 may specify that other users who attend the same university as the user 102 and/or 104 may view the user's pictures, but that other users who are family members of the user 102 and/or 104 may not view those same pictures.

In particular examples, the social networking system 106 may provide one or more default privacy settings for each object of a particular object-type. A privacy setting for an object that is set to a default may be changed by a user associated with that object. As an example, and not by way of limitation, all images posted by the user 102 and/or 104 may have a default privacy setting of being visible only to friends of the first user and, for a particular image, the user 102 and/or 104 may change the privacy setting for the image to be visible to friends and friends-of-friends.

In particular examples, privacy settings may allow the user 102 and/or 104 to specify (e.g., by opting out, by not opting in) whether the social networking system 106 may receive, collect, log, or store particular objects or information associated with the user 102 and/or 104 for any purpose. In particular examples, privacy settings may allow the user 102 and/or 104 to specify whether particular applications or processes may access, store, or use particular objects or information associated with the user. The privacy settings may allow the user 102 and/or 104 to opt in or opt out of having objects or information accessed, stored, or used by specific applications or processes. The social networking system 106 may access such information in order to provide a particular function or service to the user 102 and/or 104, without the social networking system 106 having access to that information for any other purposes. Before accessing, storing, or using such objects or information, the social networking system 106 may prompt the user 102 and/or 104 to provide privacy settings specifying which applications or processes, if any, may access, store, or use the object or information prior to allowing any such action. As an example, and not by way of limitation, the user 102 and/or 104 may transmit a message to the user 102 and/or 104 via an application related to the online social network (e.g., a messaging app), and may specify privacy settings that such messages should not be stored by the social networking system 106.

In particular examples, the user 102 and/or 104 may specify whether particular types of objects or information associated with the user 102 and/or 104 may be accessed, stored, or used by the social networking system 106. As an example, and not by way of limitation, the user 102 and/or 104 may specify that images sent by the user 102 and/or 104 through the social networking system 106 may not be stored by the social networking system 106. In some examples, the user 102 and/or 104 may specify that messages sent from the user 102 and/or 104 to another user may not be stored by the social networking system 106. In some cases, the user 102 and/or 104 may specify that all objects sent via a particular application may be saved by the social networking system 106.

In particular examples, privacy settings may allow the user 102 and/or 104 to specify whether particular objects or information associated with the user 102 and/or 104 may be accessed from particular client systems or third-party systems. The privacy settings may allow the user 102 and/or 104 to opt in or opt out of having objects or information accessed from a particular device (e.g., the phone book on a user's smart phone), from a particular application (e.g., a messaging app), or from a particular system (e.g., an email server). The social networking system 106 may provide default privacy settings with respect to each device, system, or application, and/or the user 102 and/or 104 may be prompted to specify a particular privacy setting for each context. As an example, and not by way of limitation, the user 102 and/or 104 may utilize a location-services feature of the social networking system 106 to provide recommendations for restaurants or other places in proximity to the user 102 and/or 104. The default privacy settings of the user 102 and/or 104 may specify that the social networking system 106 may use location information provided from the computing device 110 and/or 112 of the user 102 and/or 104 to provide the location-based services, but that the social networking system 106 may not store the location information of the user 102 and/or 104 or provide it to any third-party systems. The user 102 and/or 104 may then update the privacy settings to allow location information to be used by a third-party image-sharing application in order to geo-tag photos.

In particular examples, privacy settings may allow a user to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, a user may specify that a particular image uploaded by the user is visible to the user's friends for the next week, after which time the image may no longer be accessible to other users. In some examples, a company may post content related to a product release ahead of the official launch and specify that the content may not be visible to other users until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of a user associated with the objects or information, and may subsequently delete the objects or information, as specified by the respective privacy settings. As an example, and not by way of limitation, the user 102 may transmit a message to the user 104, and the social networking system 106 may temporarily store the message in a data store until the user 104 has viewed or downloaded the message, at which point the social networking system 106 may delete the message from the data store. In some examples, continuing with the prior example, the message may be stored for a specified period of time (e.g., 2 weeks), after which point the social networking system 106 may delete the message from the data store.

In particular examples, changes to privacy settings may take effect retroactively, affecting the visibility of objects and content shared prior to the change. As an example, and not by way of limitation, the user 102 may share a first image and specify that the first image is to be public to all other users. At a later time, the user 102 and/or 104 may specify that any images shared by the user should be made visible only to a first user group. The social networking system 106 may determine that this privacy setting also applies to the first image and make the first image visible only to the first user group. In particular examples, the change in privacy settings may take effect only going forward. Continuing the example above, if the user 102 and/or 104 changes privacy settings and then shares a second image, the second image may be visible only to the first user group, but the first image may remain visible to all users. In particular examples, in response to a user action to change a privacy setting, the social networking system 106 may further prompt the user to indicate whether the user wants to apply the changes to the privacy setting retroactively. In particular examples, a user change to privacy settings may be a one-off change specific to one object. In particular examples, a user's change to privacy may be a global change for all objects associated with the user.

In particular examples, the social networking system 106 may determine that user 102 and/or 104 may want to change one or more privacy settings in response to a trigger action associated with the user 102 and/or 104. The trigger action may be any suitable action on the online social network. As an example, and not by way of limitation, a trigger action may be a change in the relationship between a first and second user of the online social network (e.g., “un-friending” a user, changing the relationship status between the users, etc.). In particular examples, upon determining that a trigger action has occurred, the social networking system 106 may prompt the user 102 and/or 104 to change the privacy settings regarding the visibility of objects associated with the user 102 and/or 104. The prompt may redirect the user 102 and/or 104 to a workflow process for editing privacy settings with respect to one or more entities associated with the trigger action. The privacy settings associated with the user 102 and/or 104 may be changed only in response to an explicit input from the user 102 and/or 104 and may not be changed without the approval of the user 102 and/or 104. As an example, and not by way of limitation, the workflow process may include providing the user 102 with the current privacy settings with respect to the user 104 or to a group of users (e.g., un-tagging the user 102 or the user 104 from particular objects, changing the visibility of particular objects with respect to the user 104 or a group of users), and receiving an indication from the user 102 to change the privacy settings based on any of the methods described herein, or to keep the existing privacy settings.

In particular examples, a user may need to provide verification of a privacy setting before allowing the user to perform particular actions on the online social network, or to provide verification before changing a particular privacy setting. When performing particular actions or changing a particular privacy setting, a prompt may be presented to the user to remind the user of his or her current privacy settings and to ask the user to verify the privacy settings with respect to the particular action. Furthermore, a user may need to provide confirmation, double-confirmation, authentication, or other suitable types of verification before proceeding with the particular action, and the action may not be complete until such verification is provided. As an example, and not by way of limitation, a user's default privacy settings may indicate that a person's relationship status is visible to all users (i.e., “public”). However, if the user changes his or her relationship status, the social networking system 106 may determine that such action may be sensitive and may prompt the user to confirm that his or her relationship status should remain public before proceeding. In some examples, a user's privacy settings may specify that the user's posts are visible only to friends of the user. However, if the user changes the privacy setting for his or her posts to being public, the social networking system 106 may prompt the user with a reminder of the user's current privacy settings of posts being visible only to friends, and a warning that this change will make all of the user's past posts visible to the public. The user may then be required to provide a second verification, input authentication credentials, or provide other types of verification before proceeding with the change in privacy settings. In particular examples, a user may need to provide verification of a privacy setting on a periodic basis. A prompt or reminder may be periodically sent to the user based either on time elapsed or a number of user actions. As an example, and not by way of limitation, the social networking system 106 may send a reminder to the user to confirm his or her privacy settings every six months or after every ten photo posts. In particular examples, privacy settings may also allow users to control access to the objects or information on a per-request basis. As an example, and not by way of limitation, the social networking system 106 may notify the user whenever a third-party system attempts to access information associated with the user and require the user to provide verification that access should be allowed before proceeding.

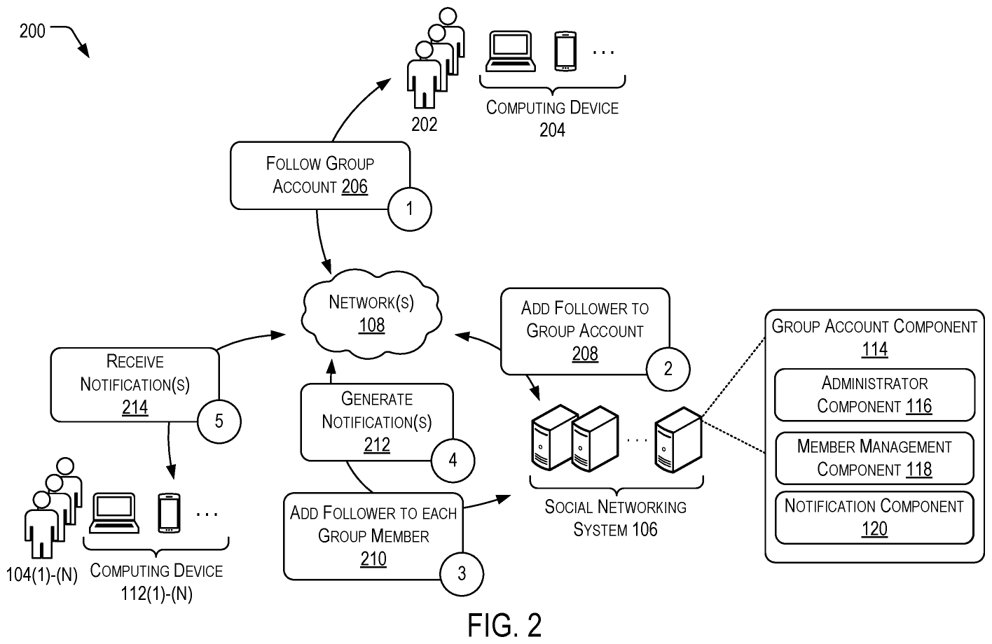

FIG. 2 is a view of another example system 200 usable to assist a user 202 in following members of a group account, according to some implementations. As discussed above, the system 200 may allow a group account to have a set of group members, generally indicated as users 104(1)-(N) and the user 202 may interact with the social networking system 106 via the network 108 using computing devices, generally indicated by 204.

As discussed above with respect to FIG. 1, the social networking system 106 may include the group account component 114. The group account component 114 may include a number of sub-components or modules, such as the administrator component 116, the member management component 118, the follower component 120, as well as other components.

With respect to FIG. 2, the user 202 may navigate to, access, and apply to follow the group account via the computing device 204 and the social networking system 106. For instance, in the illustrated example, the user 202 may, at operation 206 (indicated by “1”), using an application associated with the social networking system 106 and hosted on the computing device 204, provide a user input to follow the group account associated with the members (e.g., users 104).

At operations 208 (indicated by “2”), the social networking system 106 may then, in response to the user input, add the user 202 as a follower of the group account. As a follower, the user 202 may receive updates, content, interactions, and/or other information associated with the group account via one or more notifications, feeds, and the like of the social networking system 106.

At operation 210 (indicated by “3”), the social networking system 106 may add the user 202 as a follower of individual members of the group account. As a follower of the individual group members, the user 202 may also receive updates, content, interactions, and/or other information associated with each individual group member via one or more notifications, feeds, and the like of the social networking system 106. Accordingly, by applying as a follower of the group account, the user account of the user 202 becomes a follower of the group account as well as the individual group members via a single interaction with the social networking system 106.

At operation 212 (indicated by “4”), the social networking system may send a notification related of the content to the members (e.g., users 104) and, at operation 214 (indicated by “5”), the members may receive the notification. In some cases, the notification may be a message, a posting of the content or the notification to a particular location associated with the member, such as a feed or the like. In some cases, the notification may provide an indication to the individual members that they have received new followers as a result of being a member of the group account. In some cases, the social networking system 106 may provide statistics related to, for instance, a number of followers gained due to the membership or association with the group account, a length of time, a follower growth rate (such as an average growth over a period of time), and the like.

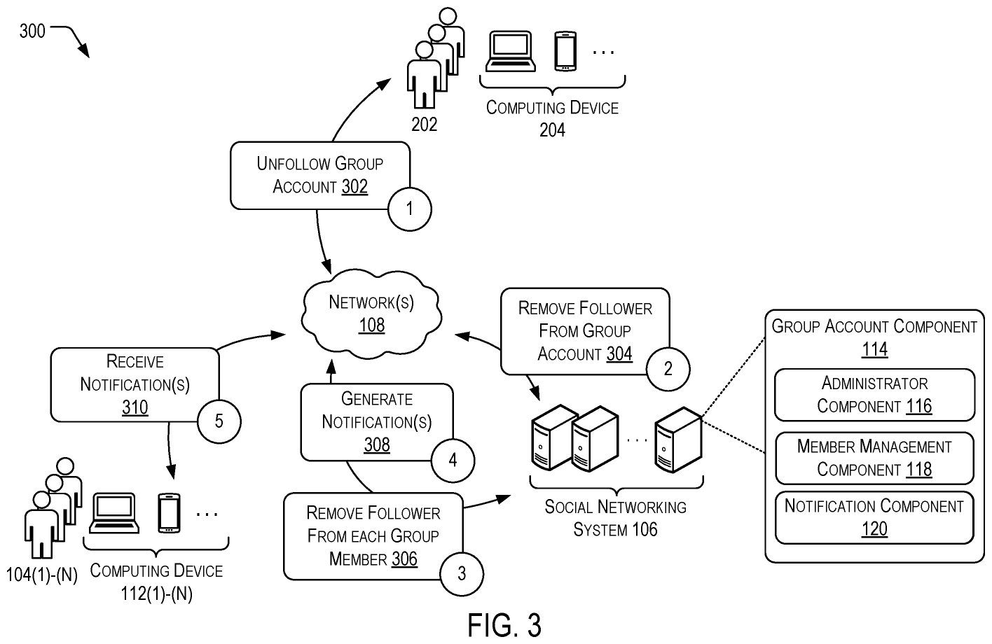

FIG. 3 is a view of another example system 300 usable to assist the user 202 in unfollowing members of a group account, according to some implementations. As discussed above, the system 300 may allow a group account to have a set of group members, generally indicated as users 104(1)-(N) and the user 202 may interact with the social networking system 106 via the network 108 using computing devices, generally indicated by 204.

As discussed above with respect to FIG. 1, the social networking system 106 may include the group account component 114. The group account component 114 may include a number of sub-components or modules, such as the administrator component 116, the member management component 118, the follower component 120, as well as other components.

With respect to FIG. 3, the user 202 may navigate to, access, and unfollow the group account via the computing device 204 and the social networking system 106. For instance, in the illustrated example, the user 202 may, at operation 302 (indicated by “1”), using an application associated with the social networking system 106 and hosted on the computing device 204, provide a user input to unfollow the group account associated with the members.

At operations 304 (indicated by “2”), the social networking system 106 may then, in response to the user input, remove the user 202 as a follower of the group account. Accordingly, the user 202 may no longer receive updates, content, interactions, and/or other information associated with the group account via one or more notifications, feeds, and the like of the social networking system 106.

At operation 306 (indicated by “3”), the social networking system 106 may remove the user 202 as a follower of individual members of the group account (e.g., individual ones of the users 104). In this manner, the user 202 may no longer receive updates, content, interactions, and/or other information associated with each individual group member via one or more notifications, feeds, and the like of the social networking system 106.

At operation 308 (indicated by “4”), the social networking system may send a notification related to the content to the members (e.g., users 104) and, at operation 310 (indicated by “5”), the members may receive the notification. In some cases, the notification may be a message, a posting of the content or the notification to a particular location associated with the member, such as a feed or the like. In some cases, the notification may provide an indication to the individual members that they have lost a follower as a result of being a member of the group account.

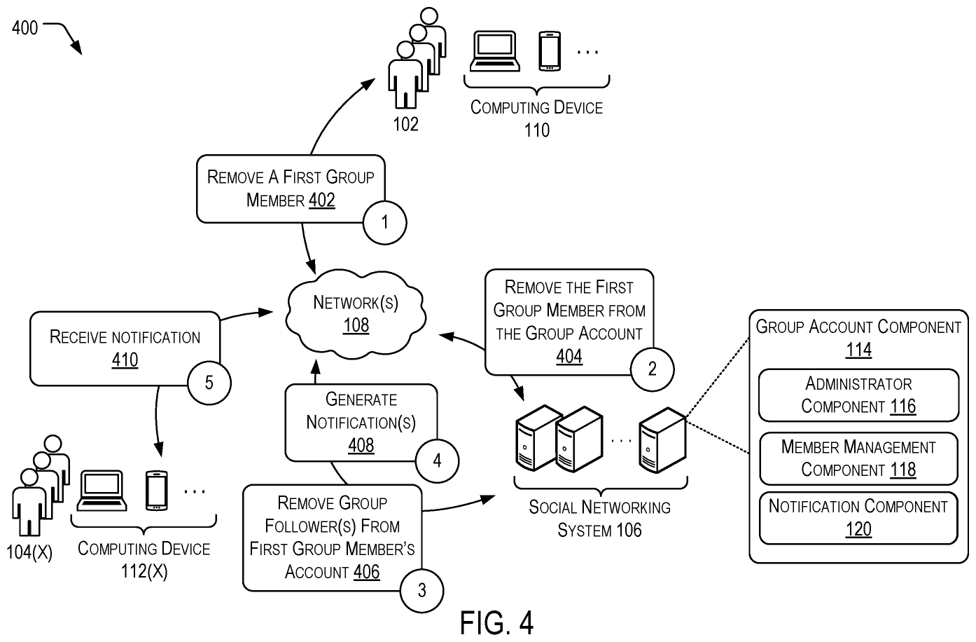

FIG. 4 is a view of yet another example system 400 usable to assist with managing members of a group account, according to some implementations. In this example, the administrator 102 may have permissions associated with the group account that allow the administrator 102 to add and/or remove members via the social networking system 106 and the computing devices 110 (e.g., via an application associated with the social networking system 106). For instance, in the illustrated example, the administrator user 102 may be removing a member (e.g., user 104(X)) from the group account.

In this example, the social networking system 106 may again include the group account component 114, and the group account component 114 may include the administrator component 116, the member management component 118, and/or the follower component 120.

With respect to FIG. 4, at operation 402 (indicated by “1”), the administrator user 102 may access the group account via the computing devices 110 and remove a first group member (e.g., user 104(X) in this example) from the group account. For example, as discussed above, the first group member may no longer be associated with the group, such as when an actor is no longer associated with a television program.

At operation 404 (indicated by “2”), the social networking system 106 may remove the first group member (e.g., user 104(X)) from the group account. For example, the first group member may be removed from a membership list associated with the group account and will no longer appear in searches and the like associated with the group account.

At operation 406 (indicated by “3”), the social networking system 106 may also remove the group followers (e.g., users that have followed the group account) as followers from the first group member account. For instance, as the first group member (e.g., user 104(X)) is no longer associated with the group account, the users following the group account may no longer be interested in content and information associated with the first group member and, as such, the association between the first group member and the group member followers may be removed. In other examples, it should be understood that the social networking system 106 may maintain the relationship (e.g., the followers) of the first group member even though the member is no longer associated with the group account. In still other examples, the social networking system 106 may notify the followers of the disassociation between the first member and the group account and allow individual followers to opt-out of following the first member.

At operation 408 (indicated by “4”), the social networking system 106 may generate and/or send a notification to the first group member (e.g., user 104(X)) regarding his or her removal from the group and, at operation 410 (indicated by “5”), the first group member may receive the notification. In one particular example, the notification may allow the first group member to determine if the followers of the group account will continue as followers of the first group member or if the social networking system 106 should remove the relationship.

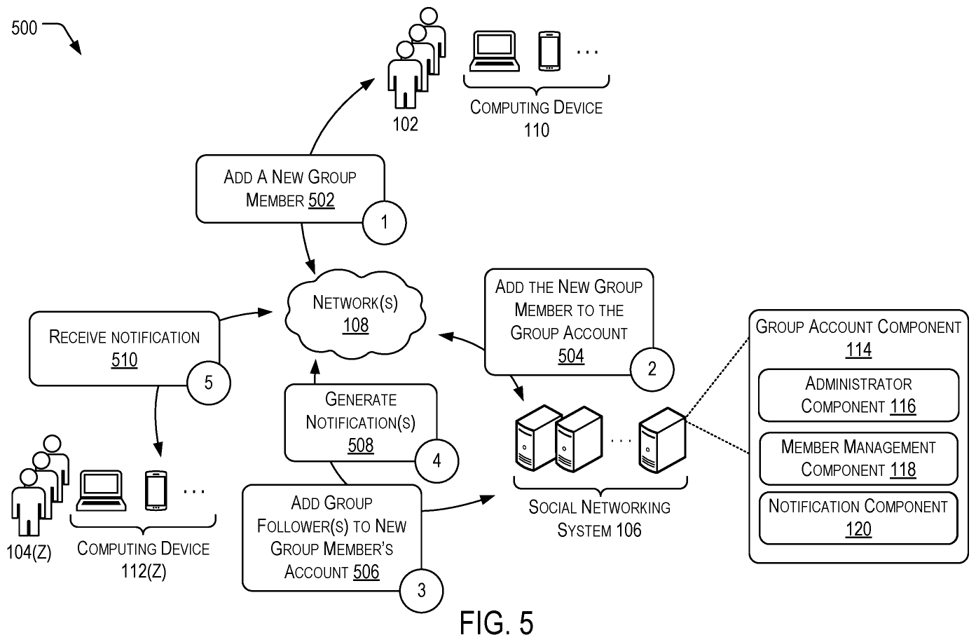

FIG. 5 is a view of yet another example system 500 usable to assist with managing members of a group account, according to some implementations. In this example, the administrator 102 may have permissions associated with the group account that allow the administrator 102 to add and/or remove members via the social networking system 106 and the computing devices 110 (e.g., via an application associated with the social networking system 106). For instance, in the illustrated example, the administrator user 102 may be adding a new member (e.g., user 104(Z)) to the group account.

In this example, the social networking system 106 may again include the group account component 114, and the group account component 114 may include the administrator component 116, the member management component 118, and/or the follower component 120.

With respect to FIG. 5, at operation 502 (indicated by “1”), the administrator user 102 may access the group account via the computing devices 110 and add a new group member (e.g., user 104(Z) in this example) to the group account. For example, as discussed above, the new group member may be newly associated with the group account, such as when an actor is added to the cast of a television program in the middle of a season or at the start of a new season.

At operation 504 (indicated by “2”), the social networking system 106 may add the new group member to the group account. For example, the new group member may be added to a membership list associated with the group account and will start to appear in searches and the like associated with the group account.

At operation 506 (indicated by “3”), the social networking system 106 may also add the group followers (e.g., users that have followed the group account) as follower of the account of the new group member (e.g., user 104(Z)). For instance, as the new group member is now associated with the group account, the users following the group account may desire to receive content and information associated with the new group member due to the association of the new group member with the group account. In other examples, the social networking system 106 may notify the followers of the association between the new group member and the group account and allow individual followers to opt-in to following the new group member.

At operation 508 (indicated by “4”), the social networking system 106 may generate and/or send a notification to the new group member (e.g., user 104(Z)) regarding his addition to the group and, at operation 510 (indicated by “5”), the new group member may receive the notification. In some cases, the social networking system 106 may refrain or delay adding the new group member to the group until the new group member confirms via the notification that they desire to join the group account. In this manner, the operations 504 and 506 may be delayed or performed after operations 508 and 510. In one particular example, the notification may also allow the new group member to determine if the followers of the group account will be added as followers of the account of the new group member.

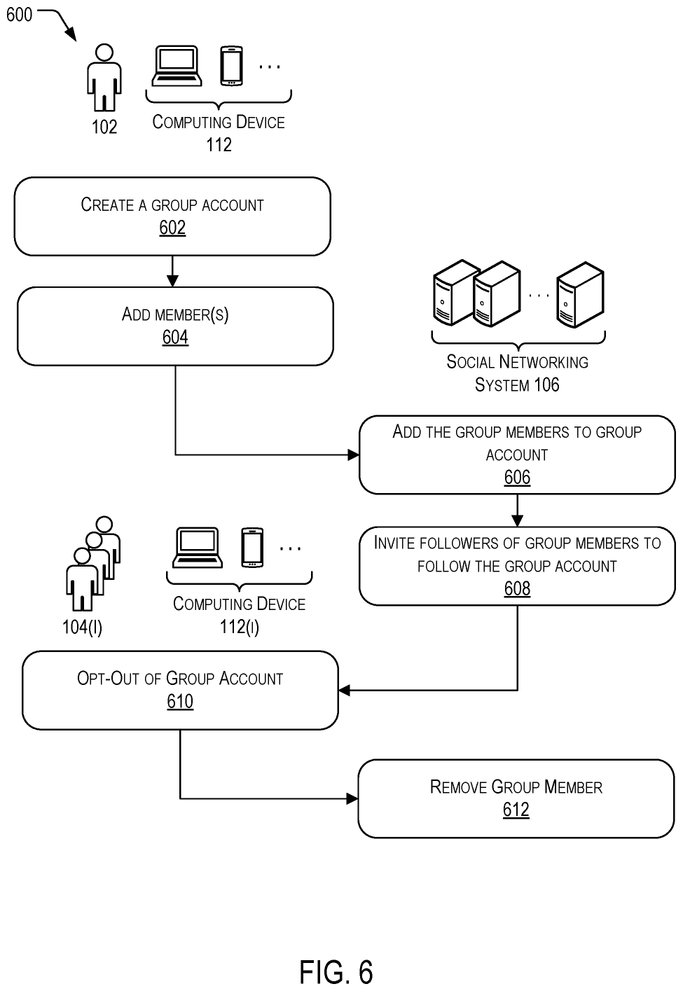

FIGS. 6-10 are flow diagrams illustrating example processes associated with the group accounts as discussed above. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, which when executed by one or more processors, perform the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 6 is a flow diagram illustrating an example process 600 associated with group accounts according to some implementations. As discussed above, the system may be configured to provide group accounts which allow for a user of a social networking system to follow and/or unfollow the individual members of the group account via a single interaction with the social networking system. The system also allows for automated following and unfollowing of members of the group account as the membership is changed by, for instance, an administrator.

At 602, the administrator user 102 may create a group account. For example, the administrator user 102 may create an account in a manner of an individual user creating a personal account but select a group or aggregation account option allowing multiple users to be members of the group account. In some cases, the administrator user 102 may specify identifying content (e.g., account name, address, and the like), background content (e.g., account story, purpose, goals, and the like), demographic or contact content (e.g., personal information of the group), initial content (e.g., original posts and the like), and the like to associate and/or publish with respect to the group account.

At 604, the administrator user 102 may add members to the group account. For example, the administrator user 102 may select a user 104(I) by typing or entering the user's name, selecting the user 104(I) from a list or other tagged content, and the like. In some cases, the membership process may include sending an invitation to the user 104(I) that the user 104(I) may accept prior to the user 104(I) becoming a member. In other cases, the user 104(I) may be added without an acceptance or following a period of time elapsing without the user 104(I) opting-out of the group account. In this example, 604 is separated from 602 but it should be understood that in some cases, the administrator user 102 may add members during the creation of the group account.

At 606, the social networking system 106 may add the group members to the group account and/or otherwise facilitate the creation of the group account. For example, the social networking system 106 may list the user 104(I) as a member with respect to the group account and/or content associated therewith. The social networking system 106 may also, in an alternative example, invite the user 104(I) to the group account and delay adding the user 104(I) until an acceptance is received.

At 608, the social networking system 106 may invite followers of the group members to follow the group account. In other examples, the social networking system 106 may add the followers of the members as followers of the group account without sending and invitation or awaiting an acceptance reply. In one example, the system 106 may allow the followers to opt-out for a period of time prior to being added upon the expiration of the period of time as a follower of the group account.

At 610, one of the members, user 104(I), may out-out of the group account. For example, the user may ignore an invitation and/or provide a user input to opt-out of the group membership. In this manner, the social networking system 106 may avoid administrators adding other users to a group without the user's knowledge.

At 612, the social networking system 106 may remove the group member, e.g., user 104(I), from the group account. In other examples, the user 104(I) may not be added until the user 104(I) accepts the invitation. In some cases, when the user is removed as a member of the group account, the social networking system 106 may remove any relationship (e.g., a following relationship) between the followers of the group account and the member being removed, e.g., user 104(I).

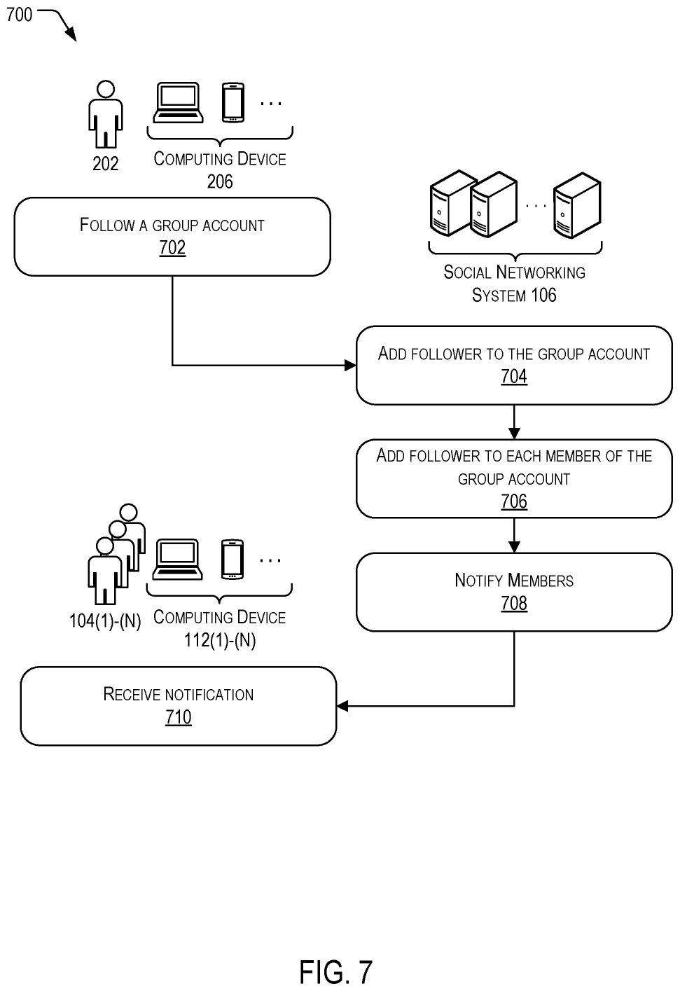

FIG. 7 is another flow diagram illustrating an example process 700 associated with group accounts according to some implementations. As discussed above, the system, discussed herein, may be configured to provide group accounts which allow for a user of a social networking system to follow and/or unfollow the individual members of the group account via a single interaction with the social networking system. The system also allows for automated following and unfollowing of members of the group account as the membership is changed by, for instance, an administrator.

At 702, a user 202 of the social networking system 106 may follow a group account. For instance, the user 202 may, using an application associated with the social networking system 106 and hosted on the computing device 204, provide a user input to follow the group account associated with the members of the group, such as selecting a follow icon with regards to content associated with the group account.

At 704, the social networking system 106 may add the user 202 as a follower of the group account. For example, the user 202 may be added as a follower such that the user 202 may receive content, information, and the like associated with the interactions of the group account with the social networking system 106. As an example, the user 202 may receive notifications or feeds associated with content posted to the social networking system 106 by the group account.

At 706, the social networking system 106 may add the user 202 as a follower to each member of the group account. As a follower of the individual group members, the user 202 may also receive updates, content, interactions, and/or other information associated with each individual group member via one or more notifications, feeds, and the like of the social networking system 106. Accordingly, by applying as a follower of the group account, the user account of the user 202 becomes a follower of the group account as well as the individual group members via a single interaction with the social networking system 106.

At 708, the social networking system 106 may notify the members as to the new follower and, at 710, the members may receive the notification. In some cases, the notification may request the members each accept the follower prior to the user 202 being added as a follower of the individual account.

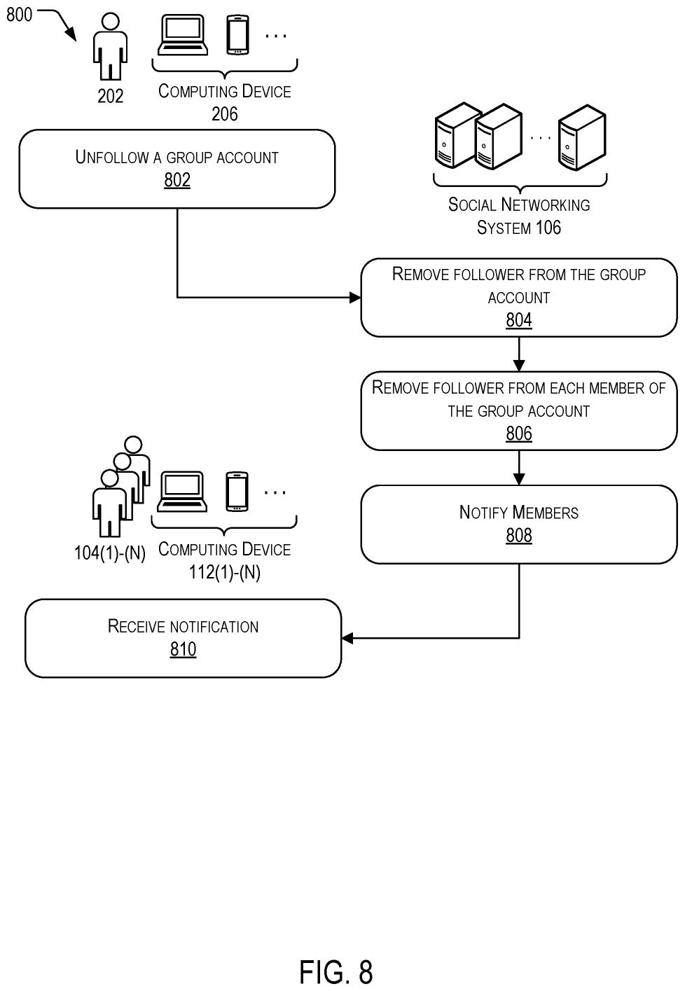

FIG. 8 is another flow diagram illustrating an example process 800 associated with group accounts according to some implementations. As discussed above, the system may be configured to provide group accounts which allow for a user of a social networking system to follow and/or unfollow the individual members of the group account via a single interaction with the social networking system. The system also allows for automated following and unfollowing of members of the group account as the membership is changed by, for instance, an administrator.

At 802, a user 202 of the social networking system 106 may unfollow a group account. For instance, the user 202 may, using an application associated with the social networking system 106 and hosted on the computing device 204, provide a user input to unfollow the group account associated with the members, such as selecting a unfollow icon with regards to content associated with the group account.

At 804, the social networking system 106 may remove the user 202 as a follower of the group account. For example, the user 202 may be removed as a follower such that the user 202 may no longer receive content, information, and the like associated with the interactions of the group account with the social networking system 106.

At 806, the social networking system 106 may remove the user 202 as a follower to each member of the group account. Again, as the user 202 may be removed as a follower, the user 202 may no longer receive content, information, and the like associated with the interactions of the individual members with the social networking system 106. Accordingly, by unfollowing of the group account, the user account of the user 202 may remove themselves as a follower of the group account as well as the individual group members via a single interaction with the social networking system 106.

At 808, the social networking system 106 may notify the members as to the removal of the follower and, at 810, the members may receive the notification.

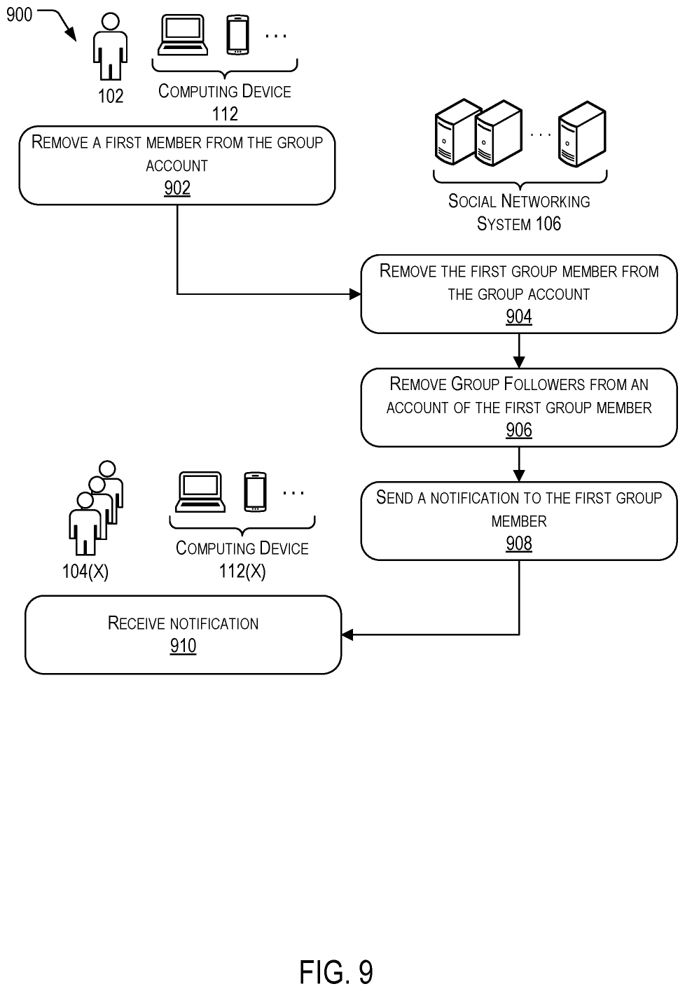

FIG. 9 is another flow diagram illustrating an example process 900 associated with group accounts according to some implementations. As discussed above, the system may be configured to provide group accounts which allow for a user of a social networking system to follow and/or unfollow the individual members of the group account via a single interaction with the social networking system. The system also allows for automated following and unfollowing of members of the group account as the membership is changed by, for instance, an administrator.

At 902, an administrator user 102 of a group account may remove a first group member from the group account membership. For example, as discussed above, the first group member may no longer be associated with the group account, such as when an actor is no longer associated with a television program.

At 904, the social networking system 106 may remove the first group member from the group account. For example, the first group member may be removed from a membership list associated with the group account and will no longer appear in searches and the like associated with the group account.

At 906, the social networking system 106 may also remove the group followers (e.g., users that have followed the group account) as followers from the account of the first group member. For instance, as the first (now former) group member is no longer associated with the group account, the users following the group account may no longer be interested in content and information associated with the first/former group member and, as such, the association between the first/former group member and the group member followers may be removed. In other examples, it should be understood that the social networking system 106 may maintain the relationship (e.g., the followers) of the first group member even though the first group member 104(X) is no longer associated with the group account. In still other examples, the social networking system 106 may notify the followers of the disassociation between the first group member and the group account and allow individual followers to opt-out of following the first group member.

At 908, the social networking system 106 may generate and/or send a notification to the first group member regarding his or her removal from the group and, at 910, the first group member may receive the notification. In one particular example, the notification may allow the first group member to determine if the followers of the group account will continue as followers or if the social networking system 106 should remove the relationship.

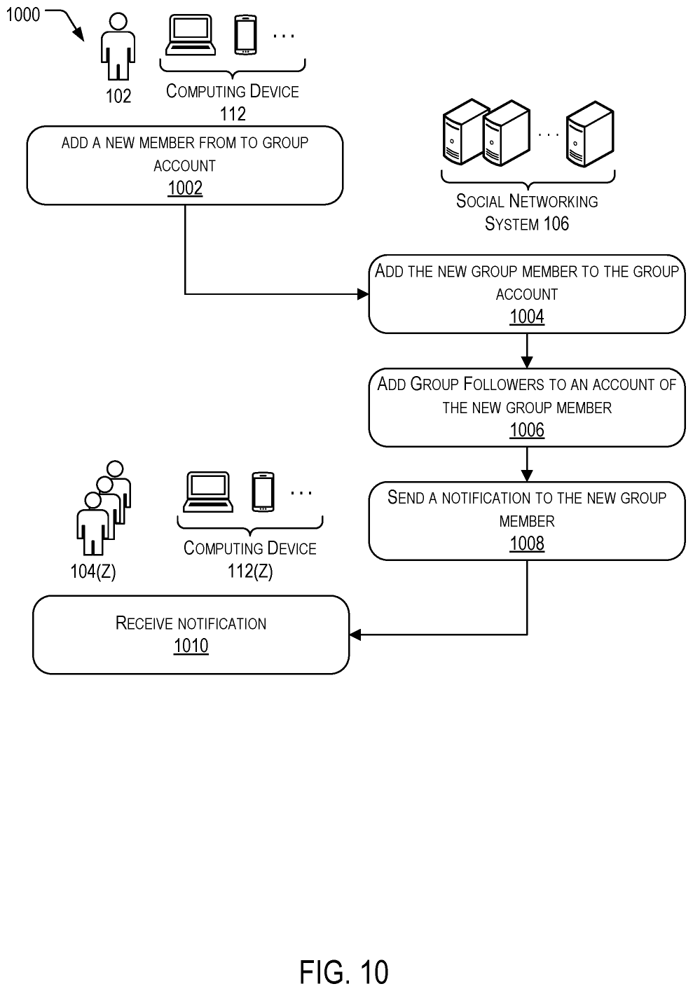

FIG. 10 is another flow diagram illustrating an example process 1000 associated with group accounts according to some implementations. As discussed above, the system may be configured to provide group accounts which allow for a user of a social networking system to follow and/or unfollow the individual members of the group account via a single interaction with the social networking system. The system also allows for automated following and unfollowing of members of the group account as the membership is changed by, for instance, an administrator.

At 1002, an administrator user 102 may access the group account via the computing devices 110 and add a new group member to the group account. For example, as discussed above, the new group member may be newly associated with the group account, such as when an actor is added to the cast of a television program in the middle of a season or at the start of a new season.

At 1004, the social networking system 106 may add the new group member to the group account. For example, the new group member may be added to a membership list associated with the group account and will start to appear in searches and the like associated with the group account.

At 1006, the social networking system 106 may also add the group followers (e.g., users that have followed the group account) as followers of the account of the new group member. For instance, as the new group member is now associated with the group account, the users following the group account may desire to receive content and information associated with the new group member due to the association of the new group member with the group account. In other examples, the social networking system 106 may notify the followers of the association between the new group member and the group account and allow individual followers to opt-in to following the new group member.

At 1008, the social networking system 106 may generate and/or send a notification to the new group member regarding his addition to the group and, at 1010, the new group member may receive the notification. In some cases, the social networking system 106 may refrain or delay adding the new group member to the group until the new group member confirms via the notification that they desire to join the group account. In this manner, the operations 1004 and 1006 may be delayed or performed after operations 1008 and 1010. In one particular example, the notification may also allow the new group member to determine if the followers of the group account will be added as followers of the account of the new group member.

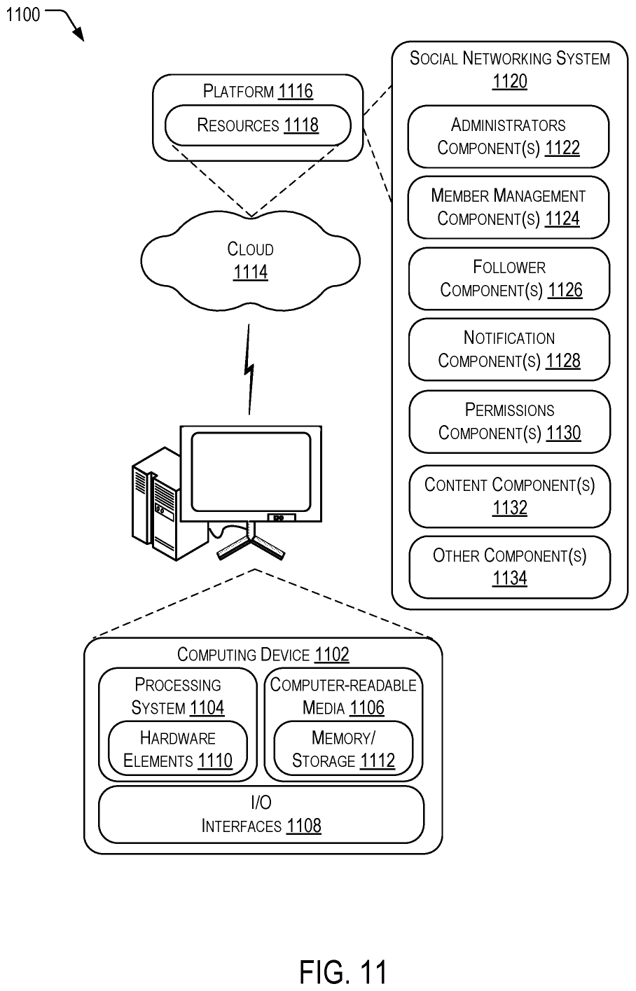

FIG. 11 illustrates an example system generally at 1100 that includes an example computing device 1102 that is representative of one or more computing systems and/or devices that may implement the various techniques described herein. This is illustrated through inclusion of a social networking system 1120 comprising an administrator component 1122, a member management component 1124, a follower component 1126, a notification component 1128, a permission component 1130, content component 1132, as well as one or more other component(s) 1134.

The administrator component 1122 may be configured to assist the administrator with managing the group account. In some cases, the administrator may assign other administrators, transfer administration rights, provide other permission and/or rights to members of the group (such as a right to post or edit group account content).

The member management component 1124 may be configured to allow the administrator(s) to modify the group members of the group account. For example, the member management component 1124 may allow the administrators to add and/or remove members from the group account.

The follower component 1126 may be configured to assist users of the social networking system 1120 in following multiple accounts via the group account interface. For example, the follower component 1126 may cause a user to follow the group account and each individual member of the group account upon a request from the user to follow the group account. In some cases, the follower component 1126 may also be configured to assist with following and unfollowing group members on behalf of followers of the group account as the group members are added and/or removed from the group account

The notification component 1128 may be configured to provide notification related to newly added content and/or feedback to, respectively, the users of the social networking system 1120 as well as upon addition of a user to the membership of the group account and/or removal from membership of the group account.

The permission component 1130 may be configured to allow an administrator to control permissions with respect to the group account. For example, permission may include, but are not limited to, rights to post content, right to edit content, rights to provide feedback, rights to message users on behalf of the group account, rights to add/remove members, and the like.

The content component 1132 may be configured to assist with generating, posting, and attributing credit for content between the members of the group account.

The computing device 1102 may be, for example, a server of a service provider, a device associated with a client (e.g., a client device), an on-chip system, and/or any other suitable computing device or computing system. The example computing device 1102 as illustrated includes a processing system 1104, one or more computer-readable media 1106, and one or more I/O interfaces 1108 that are communicatively coupled, one to another. Although not shown, the computing device 1102 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1104 is representative of functionality to perform one or more operations using hardware. Accordingly, the processing system 1104 is illustrated as including hardware elements 1110 that may be configured as processors, functional blocks, and so forth. This may include implementation in hardware as an application specific integrated circuit or other logic device formed using one or more semiconductors. The hardware elements 1110 are not limited by the materials from which they are formed, or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 1106 is illustrated as including memory/storage 1112. The memory/storage 1112 represents memory/storage capacity associated with one or more computer-readable media. The memory/storage 1112 may include volatile media (such as random access memory (RAM)) and/or nonvolatile media (such as read only memory (ROM), Flash memory, optical disks, magnetic disks, and so forth). The memory/storage 1112 may include fixed media (e.g., RAM, ROM, a fixed hard drive, and so on) as well as removable media (e.g., Flash memory, a removable hard drive, an optical disc, and so forth). The computer-readable media 1106 may be configured in a variety of other ways as further described below.

Input/output interface(s) 1108 are representative of functionality to allow a user to enter commands and information to computing device 1102, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1102 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” “logic,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on and/or transmitted across some form of computer-readable media. The computer-readable media may include a variety of media that may be accessed by the computing device 1102. By way of example, and not limitation, computer-readable media may include “computer-readable storage media” and “computer-readable transmission media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer-readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable transmission media” may refer to a medium that is configured to transmit instructions to the hardware of the computing device 1102, such as via a network. Computer-readable transmission media typically may transmit computer-readable instructions, data structures, program modules, or other data in a modulated data signal, such as carrier waves, data signals, or other transport mechanism. Computer-readable transmission media also includes any information delivery media. The term “modulated data signal” means a signal that has one or more of its characteristics set or changed in such a manner as to encode information in the signal. By way of example, and not limitation, computer-readable transmission media include wired media such as a wired network or direct-wired connection, and wireless media such as acoustic, radio frequency (RF), infrared, and other wireless media.

As previously described, hardware elements 1110 and computer-readable media 1106 are representative of modules, programmable device logic and/or device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 1110. The computing device 1102 may be configured to implement particular instructions and/or functions corresponding to the software and/or hardware modules. Accordingly, implementation of a module that is executable by the computing device 1102 as software may be achieved at least partially in hardware, e.g., through use of computer-readable storage media 1106 and/or hardware elements 1110 of the processing system 1104. The instructions and/or functions may be executable/operable by one or more articles of manufacture (for example, one or more computing devices 1102 and/or processing systems 1104) to implement techniques, modules, and examples described herein.

The techniques described herein may be supported by various configurations of the computing device 1102 and are not limited to the specific examples of the techniques described herein. This functionality may also be implemented all or in part through use of a distributed system, such as over a computing environment or “cloud” 1114 via a platform 1116 as described below.

The cloud 1114 includes and/or is representative of a platform 1116 for resources 1118. The platform 1116 abstracts underlying functionality of hardware (e.g., servers) and software resources of the cloud 1114. The resources 1118 may include applications and/or data that can be utilized while computer processing is executed on servers that are remote from the computing device 1102. Resources 1118 can also include services provided over the Internet and/or through a subscriber network, such as a cellular or Wi-Fi network.

The platform 1116 may abstract resources and functions to connect the computing device 1102 with other computing devices. The platform 1116 may also be scalable to provide a corresponding level of scale to encountered demand for the resources 1118 that are implemented via the platform 1116. Accordingly, in an interconnected device embodiment, implementation of functionality described herein may be distributed throughout multiple devices of the system 1100. For example, the functionality may be implemented in part on the computing device 1102 as well as via the platform 1116 which may represent a cloud computing environment or “cloud” 1114.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first account of a social networking system, a request to create a second account with the social networking system, the request indicating a third account with the social networking system to associate with the second account;
sending, to the third account, an invitation to be associated with the second account;
receiving, from the third account, an acceptance of the invitation;
adding, in response to receiving the acceptance, the third account as a member of the second account;
receiving, from a fourth account, an input indicating an interest in content associated with the second account;
creating, in response to receiving the input, a first relationship between the fourth account and the second account; and
creating, in response to receiving the input, a second relationship between the fourth account and the third account.

2. The method as recited in claim 1, further comprising creating, in response to receiving the input, a third relationship between the fourth account and the first account.

3. The method as recited in claim 1, further comprising determining, prior to creating the second relationship, that the fourth account does not have a current relationship with the third account.

4. The method as recited in claim 1, further comprising:
receiving, content from the third account, the content to be hosted by the social networking system; and
sending, to the fourth account, a notification associated with the content based at least in part on the second relationship.

5. The method as recited in claim 1, further comprising:
receiving, from the fourth account, a second input requesting to terminate the first relationship;
removing, in response to receiving the second input, the first relationship between the fourth account and the second account; and
removing, in response to receiving the second input, the second relationship between the fourth account and the third account.

6. The method as recited in claim 1, further comprising:
receiving, from the first account, a second input disassociating the third account and the second account; and
removing, in response to receiving the second input, the second relationship between the fourth account and the third account.

7. The method as recited in claim 1, further comprising:
receiving, from the first account, a second input associating a fifth account with the second account;
adding, in response to receiving the second input, the fifth account as a member of the second account; and
creating, in response to adding the fifth account as the member of the second account, a third relationship between the fourth account and the fifth account.

8. One or more non-transitory computer-readable media storing instructions that, when executed by one or more processors, cause one or more computing devices to perform operations comprising:
receiving, from a first account of a social networking system, a request to add an association between a second account of the social networking system a third account with the social networking system;
adding the third account as a member of the second account;
receiving, from a fourth account, an input indicating an interest in content associated with the second account;
creating, in response to receiving the input, a first relationship between the fourth account and the second account; and
creating, in response to receiving the input, a second relationship between the fourth account and the third account.

9. The one or more non-transitory computer-readable media as recited in claim 8, wherein the operations further comprise:
creating, in response to receiving the input, a third relationship between the fourth account and the first account.

10. The one or more non-transitory computer-readable media as recited in claim 8, wherein the operations further comprise:
receiving, content from the third account, the content to be hosted by the social networking system; and
sending, to the fourth account, a notification associated with the content based at least in part on the second relationship.

11. The one or more non-transitory computer-readable media as recited in claim 8, wherein the operations further comprise:
receiving, from the fourth account, a second input requesting a termination of the first relationship;
removing, in response to receiving the second input, the first relationship between the fourth account and the second account; and
removing, in response to receiving the second input, the second relationship between the fourth account and the third account.

12. The one or more non-transitory computer-readable media as recited in claim 8, wherein the operations further comprise:
receiving, from the first account, a second input disassociating the third account and the second account; and
removing, in response to receiving the second input, the second relationship between the fourth account and the third account.

13. The one or more non-transitory computer-readable media as recited in claim 8, wherein the operations further comprise:
receiving, from the first account, a second input associating a fifth account with the second account;
adding, in response to receiving the second input, the fifth account as a member of the second account; and
creating, in response to adding the fifth account as the member of the second account, a third relationship between the fourth account and the fifth account.

14. A system comprising:
one or more processors; and
one or more computer-readable media storing instructions that, when executed by the one or more processors, cause the system to perform operations comprising:
receiving, from a first account of a social networking system, a request to add an association between a second account of the social networking system a third account with the social networking system;
adding the third account as a member of the second account;
receiving, from a fourth account, an input indicating an interest in content associated with the second account;
creating, in response to receiving the input, a first relationship between the fourth account and the second account; and
creating, in response to receiving the input, a second relationship between the fourth account and the third account.

15. The system as recited in claim 14, wherein the operations further comprise creating, in response to receiving the input, a third relationship between the fourth account and the first account.

16. The system as recited in claim 14, wherein the operations further comprise determining, prior to creating the second relationship, that the fourth account does not have a current relationship with the third account.

17. The system as recited in claim 14, wherein the operations further comprise:
receiving, content from the third account, the content to be hosted by the social networking system; and
sending, to the fourth account, a notification associated with the content based at least in part on the second relationship.

18. The system as recited in claim 14, wherein the operations further comprise:
receiving, from the fourth account, a second input requesting a termination of the first relationship;
removing, in response to receiving the second input, the first relationship between the fourth account and the second account; and
removing, in response to receiving the second input, the second relationship between the fourth account and the third account.

19. The system as recited in claim 18, wherein the operations further comprise:
receiving, from the first account, a second input disassociating the third account and the second account; and
removing, in response to receiving the second input, the second relationship between the fourth account and the third account.

20. The system as recited in claim 14, wherein the operations further comprise:
receiving, from the first account, a second input associating a fifth account with the second account;
adding, in response to receiving the second input, the fifth account as a member of the second account; and
creating, in response to adding the fifth account as the member of the second account, a third relationship between the fourth account and the fifth account.
